(19) United States
(12) Patent Application Publication
(10) Pub. No.: US 2025/0225545 A1
(43) Pub. Date: Jul. 10, 2025

(54) SYSTEMS AND METHODS FOR FORECASTING UNIQUE USER COUNTS FOR ADVERTISING CAMPAIGNS

(71) Applicant: Walmart Apollo, LLC, Bentonville, AR (US)

(72) Inventors: Konstantin Shmakov, San Jose, CA (US); Girish Sathyanarayana, Mysore, Karnataka (IN); Arpan Maheshwari, Bengaluru, Karnataka (IN); Danish Shaikh, Bangalore, Karnataka (IN); Kunal Kishore, Bangalore, Karnataka (IN); Swapnasarit Sahu, Whitefield, Karnataka (IN)

(21) Appl. No.: 18/405,147

(22) Filed: Jan. 5, 2024

(51) Int. Cl. G06Q 30/0242

(52) U.S. Cl. CPC G06Q 30/0242

(57) ABSTRACT

Systems and methods for forecasting unique user counts for advertising campaigns are disclosed. In some embodiments, a disclosed method includes: receiving, from a computing device, a user forecast request; determining, based on the user forecast request, campaign data associated with an advertising campaign; computing, based on at least one model and the campaign data, a total number of unique users forecasted to be reached by the advertising campaign in a future time period; generating forecasted user data based on the number of unique users; and transmitting, in response to the user forecast request, the forecasted user data to the computing device.

### TECHNICAL FIELD

This application relates generally to advertising and, more particularly, to systems and methods for forecasting unique user counts for advertising campaigns.

### BACKGROUND

An advertisement may be a presentation or communication to promote an item, such as a product or service, for purchase. At least some advertisements are digital advertisements, which include a digital representation of the presentation or communication, such as one displayed on a website. A sponsor of an advertisement, such as a business or an advertiser, may seek to sell the item in the advertisement. The sponsor may advertise the item in the advertisement to notify potential buyers of the sale of the item, thereby increasing the chances of selling the item. For example, the sponsor may advertise the item on a website, such as a retailer's website. In at least some examples, the advertisement may be part of an advertising campaign that identifies one or more products to promote on the website.

Advertisers can visit an online user interface for planning and setting up their advertising campaigns. During the planning phase, advertisers need accurate forecasts of how their advertising campaign will perform. Based on the forecasts provided by the publishers, the advertisers can optimize their campaigns' performance. While most current billing structures of advertising campaigns are based on cost per million (CPM) impressions, a mere forecast of advertisement impressions may not be sufficient alone. This is because delivering advertisement impressions repeatedly to the same group of users can deplete the campaign budget as intended, and may lead to a decrease in campaigns' performance. Therefore, forecasting unique user counts for advertising campaigns is a desired essential tool for advertisers to optimize their campaign performance and ensure the efficient use of their advertising budget.

### SUMMARY

The embodiments described herein are directed to systems and methods for forecasting unique user counts for advertising campaigns.

In various embodiments, a system including a non-transitory memory configured to store instructions thereon and at least one processor is disclosed. The at least one processor is operatively coupled to the non-transitory memory and configured to read the instructions to: receive, from a computing device, a user forecast request; determine, based on the user forecast request, campaign data associated with an advertising campaign; compute, based on at least one model and the campaign data, a total number of unique users forecasted to be reached by the advertising campaign in a future time period; generate forecasted user data based on the number of unique users; and transmit, in response to the user forecast request, the forecasted user data to the computing device.

In various embodiments, a computer-implemented method is disclosed. The computer-implemented method includes: receiving, from a computing device, a user forecast request; determining, based on the user forecast request, campaign data associated with an advertising campaign; computing, based on at least one model and the campaign data, a total number of unique users forecasted to be reached by the advertising campaign in a future time period; generating forecasted user data based on the number of unique users; and transmitting, in response to the user forecast request, the forecasted user data to the computing device.

In various embodiments, a non-transitory computer readable medium having instructions stored thereon is disclosed. The instructions, when executed by at least one processor, cause at least one device to perform operations including: receiving, from a computing device, a user forecast request; determining, based on the user forecast request, campaign data associated with an advertising campaign; computing, based on at least one model and the campaign data, a total number of unique users forecasted to be reached by the advertising campaign in a future time period; generating forecasted user data based on the number of unique users; and transmitting, in response to the user forecast request, the forecasted user data to the computing device.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for forecasting unique user counts for advertising campaigns, in accordance with some embodiments of the present teaching;

FIG. 2 is a block diagram of a user forecast computing device, in accordance with some embodiments of the present teaching;

FIG. 3 is a block diagram illustrating various portions of a system for forecasting unique user counts for advertising campaigns, in accordance with some embodiments of the present teaching;

FIG. 4 illustrates a system for serving online advertisements to customers, in accordance with some embodiments of the present teaching;

FIG. 5 illustrates a process for estimating unique user reach for advertising campaigns, in accordance with some embodiments of the present teaching;

FIG. 6 illustrates an exponentially saturating overlap modelling for estimating a user overlap factor, in accordance with some embodiments of the present teaching;

FIG. 7 illustrates a process for estimating unique user reach for winnable impressions, in accordance with some embodiments of the present teaching;

FIG. 8 illustrates an exemplary user interface for an advertiser to view user forecast results, in accordance with some embodiments of the present teaching;

FIG. 9 is a flowchart illustrating an exemplary method for forecasting unique user counts for advertising campaigns, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Advertisement sponsors (or advertisers) often pay a fee for an advertising campaign according to desired impressions. An impression of an advertisement is when a customer or user sees the advertisement. In practice, an impression occurs any time a user opens an app or website where the advertisement is visible. While the advertiser intends to lift the sales of an item by paying the advertisement fee based on impressions, when setting up the advertising campaign, the advertiser wants to know not only a forecast for impressions but also a forecast for a count of unique users that will be reached by the advertising campaign. This is especially true for many advertisers who conduct advertising campaigns for branding, resulting in their keen interest in reaching users effectively and broadly.

The present teaching discloses methods and systems for forecasting a count of unique users reachable by an advertising campaign. This unique user forecast will give a clear picture of how the advertisements to be served will affect the advertising campaign's key performance indicators, KPIs, such as user engagement, brand awareness, conversion rate, etc. This can help an advertiser to design effective and efficient advertising strategies.

After an advertising campaign has been set up and has started running, the advertiser may desire to modify it, e.g. due to the change in the campaign objectives or because the campaign itself is not delivering as expected. An advertising campaign's performance depends on the campaign's parameters that the advertiser sets up, such as targeting criteria, bid values, budgets, frequency constraints, campaign start date and duration, etc. Based on the forecasts provided the disclosed system, the advertisers can set up optimal values of these parameters in order to maximize their campaigns' KPIs.

In some embodiments, a disclosed system aims to address the challenge of forecasting active unique users that can be reached through online advertising campaigns, in real-time. The disclosed solution solves this forecasting problem for any future duration of the campaign, over a long-term horizon window. With millions of potential value combinations of targeting criteria, bid values, budgets, frequency constraints and duration provided by advertisers, the disclosed system can forecast unique user count even before the campaign begins. This innovative approach can handle any targeting tactic combination such as contextual targeting, behavioral targeting, or keyword targeting. In addition, the system offers a unified solution at scale while ensuring quick response time and scalability.

In some embodiments, the disclosed system provides a method for real-time forecasting of unique user count for advertising campaigns, e.g. onsite display campaigns. In some embodiments, the disclosed system uses a novel exponentially saturating overlap model and combines it with other statistical modelling techniques to forecast a unique user count. Instead of focusing on post-campaign estimates or fixed-duration forecasts, the disclosed method allows for forecast for any duration, including the long-term, even before the campaign launches, across various targeting combinations, while ensuring rapid sub-second response times. In some embodiments, disclosed method utilizes seasonality data to provide the unique user forecast in a future time period.

In some embodiments, the disclosed system provides: (1) an estimate of maximum possible user reach for a specified targeting combination and duration provided by the advertiser; and (2) expected user reach for the additional advertising campaign parameters like bid value, budget, and frequency capping constraints, specified by the advertisers. Along with the aggregated user reach forecast over the campaign duration, the disclosed system can also provide this forecast at day level. These problems are challenging and their solutions are non-trivial, because the day-wise forecasts do not automatically add up to the aggregated forecast. Thus, the disclosed solution has industry-wide applications as a campaign management tool in online display advertising to help advertisers to devise their campaign effectively.

Furthermore, in the following, various embodiments are described with respect to systems and methods for forecasting unique user counts for advertising campaigns are disclosed. In some embodiments, a disclosed method includes: receiving, from a computing device, a user forecast request; determining, based on the user forecast request, campaign data associated with an advertising campaign; computing, based on at least one model and the campaign data, a total number of unique users forecasted to be reached by the advertising campaign in a future time period; generating forecasted user data based on the number of unique users; and transmitting, in response to the user forecast request, the forecasted user data to the computing device.

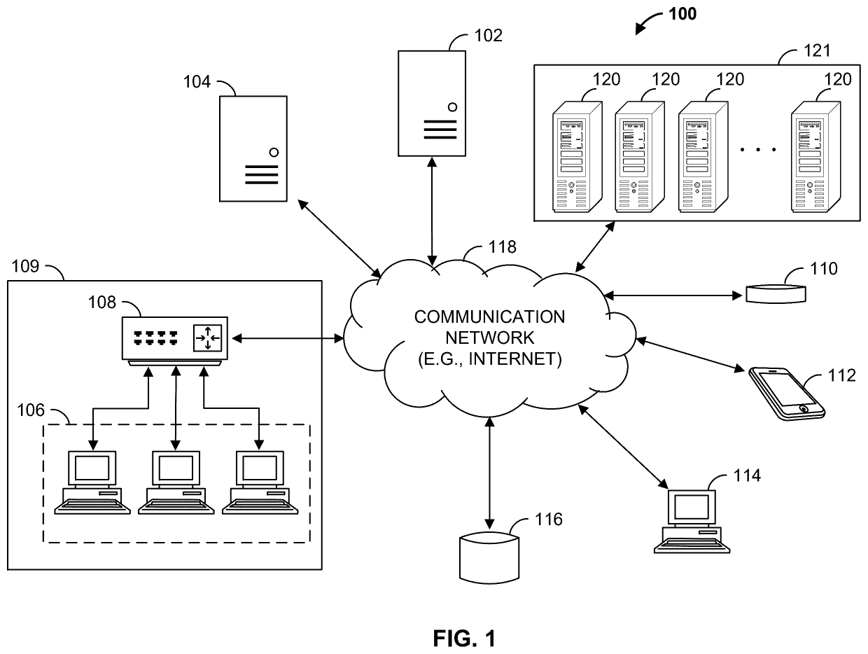

Turning to the drawings, FIG. 1 is a network environment 100 configured for forecasting unique user counts for advertising campaigns, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a user forecast computing device 102, a server 104 (e.g., a web server or an application server), a cloud-based engine 121 including one or more processing devices 120, a database 116, and one or more user computing devices 110, 112, 114 operatively coupled over the network 118. The user forecast computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the user forecast computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the user forecast computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more retailer websites. In some examples, the user forecast computing device 102, the processing devices 120, and/or the server 104 are operated by a retailer, and the multiple user computing devices 110, 112, 114 are operated by customers and/or advertisers associated with the retailer websites. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the user forecast computing device 102 over the communication network 118. The workstation(s) 106 may send data to, and receive data from, the user forecast computing device 102. For example, the workstation(s) 106 may transmit data identifying items purchased by a customer at the store 109 to the user forecast computing device 102.

Although FIG. 1 illustrates three user computing devices 110, 112, 114, the network environment 100 can include any number of user computing devices 110, 112, 114. Similarly, the network environment 100 can include any number of the user forecast computing devices 102, the processing devices 120, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, each of the multiple user computing devices 110, 112, 114 may be operable to view, access, and interact with a website, such as a retailer's website, hosted by the server 104. The server 104 may capture user session data related to a customer's activity (e.g., interactions) on the website.

In some examples, a customer may operate one of the user computing devices 110, 112, 114 to initiate a web browser that is directed to the website hosted by the server 104. The customer may, via the web browser, view item advertisements for items displayed on the website, and may click on item advertisements, for example. The website may capture these activities as user session data, and transmit the user session data to the user forecast computing device 102 over the communication network 118. The website may also allow the operator to add one or more of the items to an online shopping cart, and allow the customer to perform a “checkout” of the shopping cart to purchase the items. In some examples, the server 104 transmits purchase data identifying items the customer has purchased from the website to the user forecast computing device 102.

In some examples, an advertiser or a sponsor of advertisement, e.g., an online seller, may operate one of the user computing devices 110, 112, 114 to initiate a web browser or a user interface that is associated with a website hosted by the server 104, or a different server associated with the retailer. The advertiser may, via the web browser or the user interface, view item sets sold by the seller on the website, view and manage existing campaigns for some item sets sold by the seller, create a new campaign for an item, and run a forecast application to forecast a count of unique users who will view the advertisements of the new campaign. The website may capture at least some of these activities as campaign data. The server 104 may transmit the campaign data to the user forecast computing device 102 over the communication network 118, and/or store the campaign data to the database 116.

In some examples, the server 104 may transmit a user forecast request to the user forecast computing device 102, e.g. upon a selection of an advertiser to run the forecast application. The user forecast request may be sent standalone or together with campaign related data of the website. In some examples, the user forecast request may carry or indicate campaign data of a proposed campaign regarding an item set offered for sale on the website. The campaign data may include information about the item set, campaign start and end dates, targeting tactic, bid value, budget, etc.

In some examples, the user forecast computing device 102 may execute one or more models (e.g., programs or algorithms), such as a machine learning model, deep learning model, statistical model, etc., to forecast a total number of unique users during a future time period, e.g. next week, next month or next year. The user forecast computing device 102 may generate and transmit forecasted user data based on the total number of unique users to the server 104 over the communication network 118, and the server 104 may provide the forecasted user data to the advertiser, for the advertiser to modify and/or manage the campaign.

In some embodiments, the user forecast computing device 102 is further operable to communicate with the database 116 over the communication network 118. For example, the user forecast computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the user forecast computing device 102, in some examples, the database 116 can be a local storage device, such as a hard drive, a non-volatile memory, or a USB stick. The user forecast computing device 102 may store online purchase data received from the server 104 in the database 116. The user forecast computing device 102 may receive in-store purchase data from different stores 109 and store them in the database 116. The user forecast computing device 102 may also receive from the server 104 user session data identifying events associated with browsing sessions, and may store the user session data in the database 116. The user forecast computing device 102 may also compute forecasted user data in response to a user forecast request received from the server 104, and may store the forecasted user data in the database 116.

In some examples, the user forecast computing device 102 generates and/or updates different models for forecasting unique user counts for advertising campaigns. The models, when executed by the user forecast computing device 102, allow the user forecast computing device 102 to compute a total number of unique users forecasted to be reached by the advertising campaign in a future time period, and generate forecasted user data for an advertiser to modify and/or manage the advertising campaign.

In some examples, the user forecast computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the user forecast computing device 102 may generate forecasted user data.

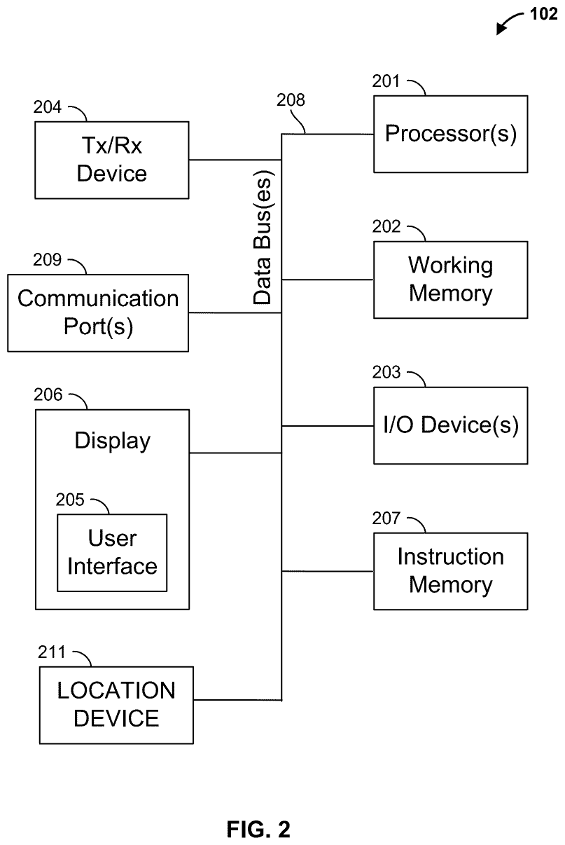

FIG. 2 illustrates a block diagram of a user forecast computing device, e.g. the user forecast computing device 102 of FIG. 1, in accordance with some embodiments of the present teaching. In some embodiments, each of the user forecast computing device 102, the server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the user forecast computing device 102 can be combined, omitted, and/or replicated. In addition, it will be appreciated that additional elements other than those illustrated in FIG. 2 can be added to the user forecast computing device 102.

As shown in FIG. 2, the user forecast computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the user forecast computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the user forecast computing device 102 can include a single memory unit configured to operate as both instruction memory and working memory. Further, although embodiments are discussed herein including non-volatile memory, it will be appreciated that the user forecast computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the user forecast computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the user forecast computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the user forecast computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the user forecast computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the user forecast computing device 102 may determine a local geographical area (e.g., town, city, state, etc.) of its position.

In some embodiments, the user forecast computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

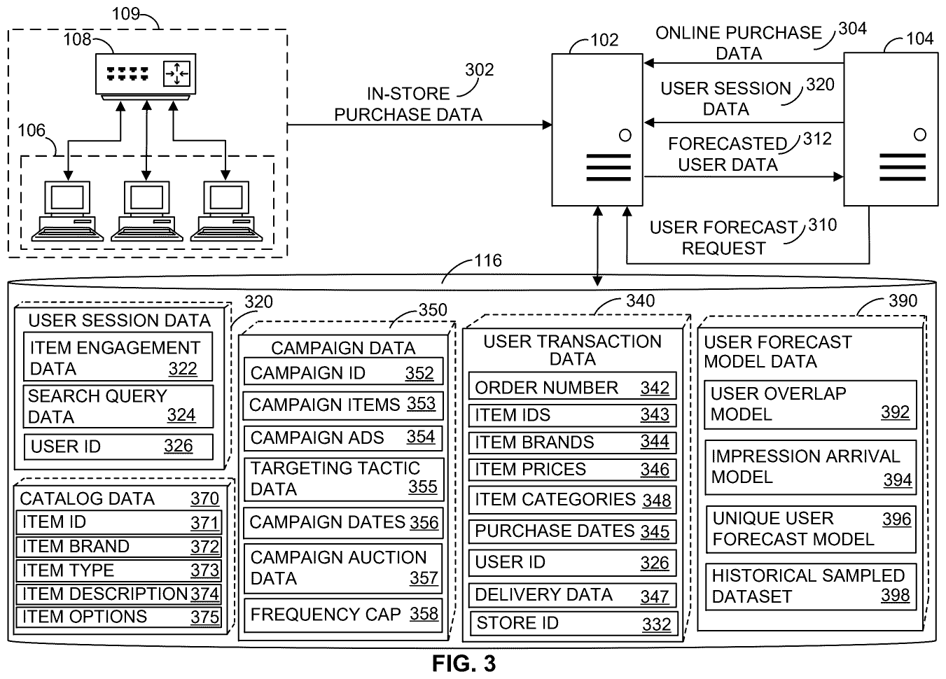

FIG. 3 is a block diagram illustrating various portions of a system for forecasting unique user counts for advertising campaigns, e.g. the system shown in the network environment 100 of FIG. 1, in accordance with some embodiments of the present teaching. As indicated in FIG. 3, the user forecast computing device 102 may receive user session data 320 from the server 104, and store the user session data 320 in the database 116. The user session data 320 may identify, for each user (e.g., customer), data related to that user's browsing session, such as when browsing a retailer's webpage hosted by the server 104.

In some examples, the user session data 320 may include item engagement data 322, search query data 324, and user ID 326 (e.g., a customer ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items added-to-cart identifying items added to the user's online shopping cart, advertisements viewed identifying advertisements the user viewed during the browsing session, and advertisements clicked identifying advertisements the user clicked on. The search query data 324 may identify one or more searches conducted by a user during a browsing session (e.g., a current browsing session). The user forecast computing device 102 may also receive online purchase data 304 from the server 104, which identifies and characterizes one or more online purchases, such as purchases made by the user and other users via a retailer's website hosted by the server 104. The user forecast computing device 102 may also receive in-store purchase data 302 from the store 109, which identifies and characterizes one or more in-store purchases. In some embodiments, the in-store purchase data 302 may also indicate other information about the store 109.

The user forecast computing device 102 may parse the in-store purchase data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (e.g., category) of each item purchased, purchase dates 345 identifying the purchase dates of the purchase orders, a user ID 326 for the user making the corresponding purchase, delivery data 347 indicating delivery information for corresponding online orders, and store ID 332 for the corresponding in-store purchase, or for the pickup store or shipping-from store associated with the corresponding online purchase.

In some embodiments, the database 116 may further store campaign data 350, which may identify data of one or more advertising campaigns proposed and/or created for the retailer's website hosted by the server 104. The campaign data 350 may identify, for each campaign, campaign ID 352 identifying the campaign, campaign items 353 identifying items promoted by the campaign, campaign advertisements 354 identifying advertisements included in the campaign, targeting tactic data 355 indicating targeting strategy and parameters set up for the campaign, campaign dates 356 identifying the start and end dates of the campaign, campaign auction data 357 indicating bid values and budget values set up for the campaign, and an optional frequency cap 358 identifying a maximum number of impressions from any user within a given time window.

In some embodiments, the database 116 may further store catalog data 370, which may identify one or more attributes of a plurality of items, such as a portion of or all items a retailer carries. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

The database 116 may also store user forecast model data 390 identifying and characterizing one or more models and related data for forecasting unique user counts. For example, the user forecast model data 390 may include a user overlap model 392, an impression arrival model 394, a unique user forecast model 396, and a historical sampled dataset 398.

The user overlap model 392 may be used to estimate an overlap factor between users on successive days. In some embodiments, the user overlap model 392 is based on an exponentially saturating overlap model to compute a parameter indicating a size increase rate of an overlap user set between unique users in N consecutive days and unique users in the (N+1)-th day. This overlap factor is key for unique user forecast, because a forecast of unique users across time is not additive in nature.

The impression arrival model 394 may be used to model the arrival of impressions from a user. In some embodiments, the impression arrival model 394 is based on a Poisson process to compute a mean of a standard Poisson distribution for the winnable impressions for an advertising campaign, given auction data like bid values and budget values of the advertising campaign. The computed mean will be used to estimate an impression-per-user ratio for a future time period.

The unique user forecast model 396 includes a model used to compute a total number of unique users forecasted to be reached by the advertising campaign in a future time period. In some examples, the unique user forecast model 396 is used to compute a maximum number of unique users to be reached by the advertising campaign in the future time period, given an assumption that the advertiser would have won all auction opportunities for the future time period. In some examples, the unique user forecast model 396 also includes a model used to compute the total number of unique users to be reached by the advertising campaign in the future time period, given the targeting tactic data 355 and the campaign auction data 357 of the advertising campaign. In some examples, the total number of unique users is also computed based on the frequency cap 358 set up for the advertising campaign.

The historical sampled dataset 398 may include historical campaign data and historical user data for advertising campaigns over a past time period, where the advertising campaigns are generated for advertisers giving the same targeting strategy and the same targeting criteria as the advertiser generating the concerned campaign. In some embodiments, the historical sampled dataset 398 is used to compute or estimate: an impression-to-user ratio for the past time period regarding the targeting strategy and the targeting criteria, an auction opportunity data for the future time period, a win rate indicating a probability of winning an auction by the advertiser, and/or a frequency cap suppression ratio representing a ratio of expected impressions to be served with the frequency cap in the future time period to expected impressions to be served without the frequency cap in the future time period. In some embodiments, the historical sampled dataset 398 includes training data used to train a machine learning model as part of the user overlap model 392, the impression arrival model 394 and/or the unique user forecast model 396.

In some examples, the user forecast computing device 102 receives a user forecast request 310 from the server 104. The user forecast request 310 may be associated with an advertising campaign generated or configured by an advertiser, who may be an online seller selling an item set on the retailer's website hosted by the server 104. For example, the server 104 may provide a user interface to the seller, to help the seller to set up parameters for the advertising campaign.

In some examples, the user forecast request 310 is to seek for forecasted user data indicating a count of unique users to be reached by the advertising campaign in one or more future time periods. Based on the user forecast request 310, the user forecast computing device 102 may determine campaign data associated with an advertising campaign. The user forecast computing device 102 may obtain at least one model and the campaign data, from the server 104 and/or the database 116. Based on the model and the campaign data, the user forecast computing device 102 may compute a total number of unique users forecasted to be reached by the advertising campaign in a future time period. The user forecast computing device 102 may also compute a day-wise forecast for unique user counts in the future time period. In some embodiments, the user forecast computing device 102 may generate forecasted user data 312 based on the total number of unique users and the day-wise forecast for unique user counts in the future time period.

In some embodiments, the user forecast computing device 102 may assign one or more of the above described operations to a different processing unit or virtual machine hosted by one or more processing devices 120. Further, the user forecast computing device 102 may transmit the forecasted user data 312 to the server 104 in response to the user forecast request 310.

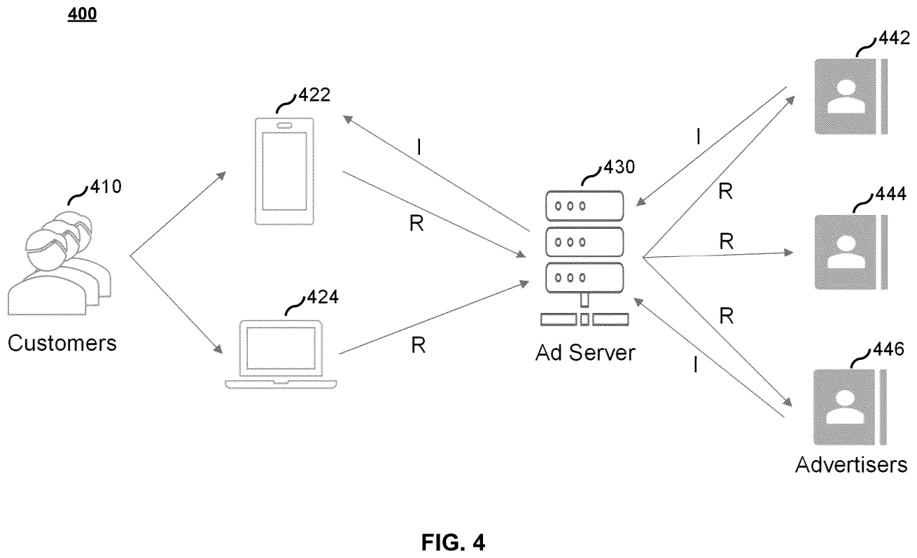

FIG. 4 illustrates a system 400 for serving online advertisements to customers, in accordance with some embodiments of the present teaching. As shown in FIG. 4, the system 400 includes: customers 410, customer computing devices 422, 424, an advertisement server 430, and advertisers 442, 444, 446.

In some examples, the customers 410 can visit an online retailer platform, via the customer computing devices 422, 424. For example, a customer may search for products on the online retailer platform using a query including one or more keywords. While search results are generated based on the keyword, advertising opportunities are created for placing one or more advertisements in the search results to be displayed o the customer. That is, an advertisement request (R) is transmitted to the advertisement server 430 after the query is entered. In response, the advertisement server 430 will provide one or more advertisements or impression (I) opportunities to be displayed together with the search results.

In some embodiments, the advertisers 442, 444, 446 have configured or created advertising campaigns at user interfaces provided by the advertisement server 430 or another server associated with the advertisement server 430. The advertisement server 430 can obtain campaign data related to all of these advertising campaigns, including bid values and budget values. Based on these campaign data, the advertisement server 430 itself or another server associated with the advertisement server 430 can perform an automatic auction process to determine which advertisement of which campaign of the advertisers 442, 444, 446 is the winner for being displayed together with the search results. For example, the winner can be determined based on: whether each campaign has a keyword targeting matching the query, whether each campaign has reached its pre-configured budget, whether each campaign has reached its frequency cap for the keyword, and/or how high is the bid value pre-set for each campaign.

In some embodiments, the advertisement server 430 can be implemented as the server 104, the user forecast computing device 102 and/or the cloud-based engine 121 in FIG. 1. In some embodiments, each of the customer computing devices 422, 424 can be implemented as one of the user computing devices 110, 112, 114 in FIG. 1.

In some embodiments, to improve winning rate or campaign performance, the advertisers 442, 444, 446 desire to obtain an accurate forecast of unique user counts in a future time period, even before the campaign is created. That is, when an advertiser is setting up a campaign with some parameters, e.g. at a user interface with the advertisement server 430 or another server associated with the advertisement server 430, the advertiser would like to run an application to achieve the forecast of unique user counts. This forecast can be computed by the advertisement server 430 or another server associated with the advertisement server 430, e.g. by the user forecast computing device 102 in FIG. 1.

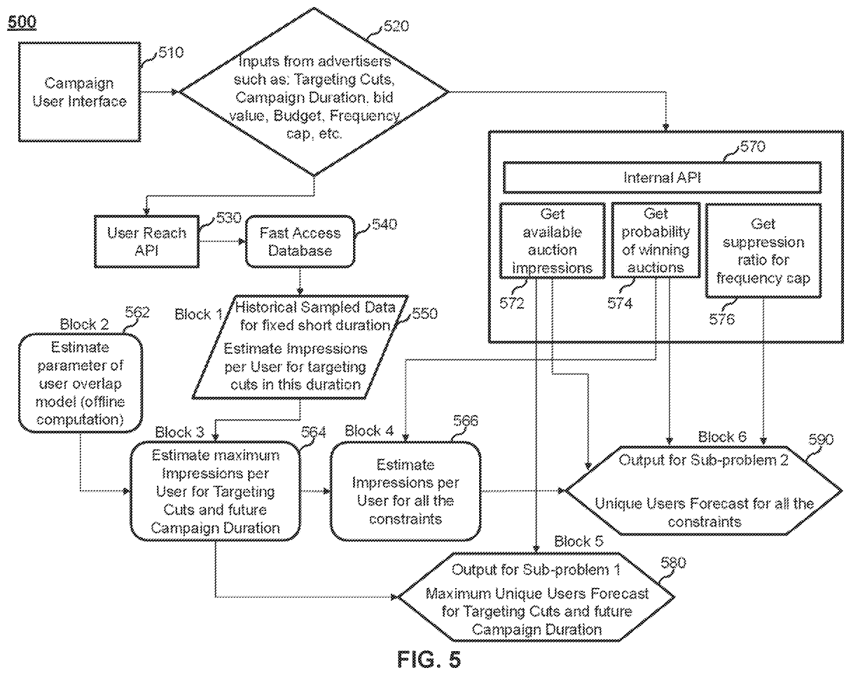

FIG. 5 illustrates a process 500 for estimating unique user reach for advertising campaigns, in accordance with some embodiments of the present teaching. In some embodiments, the process 500 can be carried out by one or more computing devices, such as the server 104 and/or the user forecast computing device 102 of FIG. 1. For example, the process 500 can be performed by the user forecast computing device 102 after receiving a user forecast request.

As shown in FIG. 5, the process 500 starts from block 510, where advertisers input their campaign parameters 520 through the campaign user interface at block 510. These parameters 520 may include e.g.: a targeting cut data (Q) indicating targeting tactic and parameters entered for a campaign, a campaign duration (T) indicating a time duration of the campaign, a bid value (b) indicating a bid value set up for the campaign, a budget (B) a budget value set up for the campaign, a frequency cap (c) indicating a threshold c that cannot be exceeded by a maximum number of impressions from any user within a given time window. The parameters 520 entered for each advertising campaign will be used as constraints to accurately forecast the count of unique users that can be reached through the advertising campaign in real-time.

In some embodiments, the user forecast problem can be deconstructed into two distinct sub-problems. In sub-problem 1, a maximum potential user reach is computed, factoring in targeting cuts Q and duration T, specified by the advertisers. Here, the maximum potential user reach refers to all the users that the advertising campaign would have reached to, assuming the advertising campaign could have won all the advertisement auction opportunities coming from Q and T. In sub-problem 2, a subset of the maximum user reach is determined, incorporating supplementary constraints such as bid value b, budget B, and frequency cap c, provided by the advertisers.

A unique user reach forecast for advertising campaigns can be estimated based on dividing the forecasted impressions by the forecasted average impressions per user. The forecasted impressions refers to total advertisement auction opportunities for sub-problem 1, and refers to winnable impressions for sub-problem 2. These forecasted impressions can be obtained from an internal application program interface (API) 570. The process 500 will be used to accurately forecast the average impressions per user for both of the sub-problems, using advanced statistical modeling techniques. First, the process 500 will provide a solution for the sub-problem 1 with the first two constraints: targeting cut Q and future campaign duration T, in block 5 580, where the solution is a maximum unique users forecast for the targeting cut Q and the future campaign duration T. Then, the process 500 will extend this solution for sub-problem 2 to incorporate additional constraints, in block 6 590, where the solution is a unique users forecast for all of the constraints obtained from the campaign parameters 520.

There are several challenges for the user forecast problem. First, the forecast of unique users across any targeting combination is not additive in nature. Hence, an approach of calculating unique users at individual targeting cut level and aggregating them to derive the total unique users forecast for the entire targeting tactics selected by an advertising campaign is not applicable. Second, advertisers' ability to specify any future campaign duration demands a real-time solution, as precomputing all possible future start date and end date combinations would be unfeasible. Because forecast of unique users across time is not additive in nature, one cannot compute unique user counts at a smaller temporal cut level (such as day) and add up daily counts together to get the count of unique users for the total campaign duration. Moreover, the solution should be able to handle any targeting combination, large scale historical data, take seasonality into account, and give response in sub-second latency. Fortunately, the disclosed method can overcome all of these challenges.

The following notations will be used for forecasting the unique user reach. Winning Impressions (WI) denotes estimated winnable impressions that will be delivered for a line item or advertising campaign. Auction Opportunities (AO) denotes an estimated number of auctions that the advertising campaign will participate in. Frequency Cap (FC) denotes a maximum number of advertisements displayed to a user within a specific timeframe. Frequency Cap suppression Ratio (FCR) denotes a ratio of expected impressions with frequency capping constraint to expected impressions without frequency capping constraint. The winrate (Q, b, B) denotes a percentage of successful bid auction, for given Q, b, B, where an advertiser's advertisement is displayed. The I(Q, T) denotes a maximum number of impressions for targeting cut Q in T days. The U(Q, T) denotes a maximum unique user reach for Q in T days. The

$$\frac{I}{U} ( Q , T )$$

denotes an impressions-to-user ratio for Q in T days. The U(Q, 1) denotes expected daily unique user reach for Q. The U_{Q}_{ₘₐₓ} denotes expected maximum unique user reach for Q over an unbounded time interval. The β denotes a parameter for an exponentially saturating overlap model. The λ_{ZTP} (Q, T) denotes an expected mean of a Zero-Truncated Poisson distribution for Q in T days. The λ(Q, T) denotes an expected mean of a Poisson process for the advertisement requests per user for Q in T days.

In some embodiments, the parameters 520 are sent to a user reach API 530 as well as the internal API 570. In some embodiments, the internal API 570 is an interface to another server or device associated with the retailer.

An initial step involves estimating impressions per user for targeting cuts over a fixed short duration, e.g. an Impressions-to-User (I/U) ratio over a specified period of D days, at block 1 550. This is estimated using a historical sampled dataset of D days stored in a fast access database 540. In some embodiments, the fast access database 540 may be part of the database 116 or a standalone database.

At block 1 550, the sampled historical D days data stored in the fast access database 540 is used to compute impressions (or advertisement auction opportunities) per user for the D days with the targeting cut Q combination given by the advertisers,

Subsequently, at block 3 564, maximum impressions per user are estimated for targeting cuts in a future campaign duration. For example, an exponentially saturating overlap model may be employed to compute the I/U ratio over a desired span of T days in future, i.e.,

$$\frac{I}{U} ( Q , T ) ,$$

in real-time at block 3 564. In some embodiments, the real-time estimate of the

$$\frac{I}{U} ( Q , T )$$

at block 3 564 is based on an offline computation of a parameter of a user overlap model, e.g. an offline estimate of a parameter β of the user overlap model, at block 2 562.

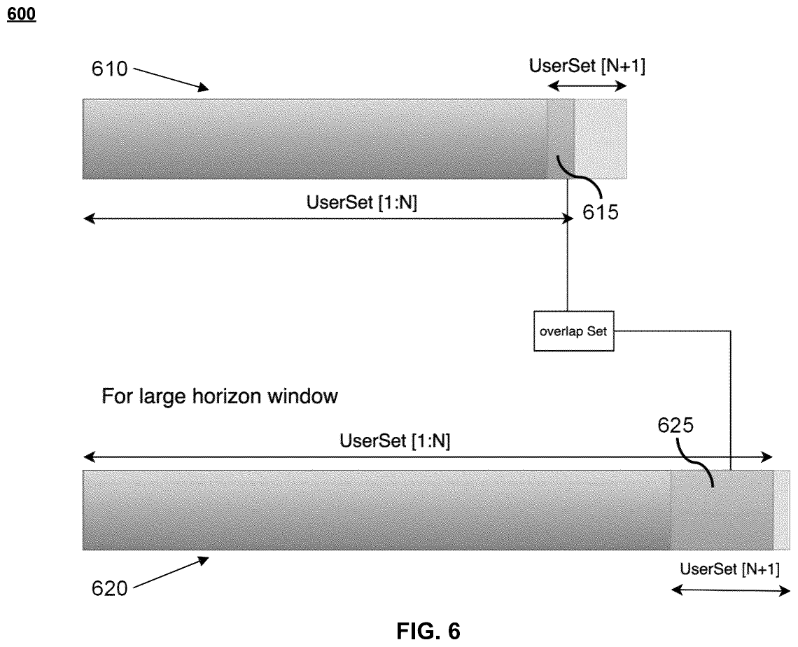

FIG. 6 illustrates an exponentially saturating overlap modelling 600 for estimating a user overlap factor, in accordance with some embodiments of the present teaching. As shown in FIG. 6, one can model the overlap factor between users on successive days using exponentially saturating overlap model with parameter β.

In some embodiments, the parameter β signifies the rate of increase in the size of overlap set between unique users in the duration of N days and unique users on the (N+1)-th day. The parameter β can be expressed as:

$$β = - log ( 1 - \frac{U ( Q , 1 )}{{U}_{{Q}_{max}}} ) \qquad [ Eq1 ]$$

where the above log expression is a non-linear function to compute the rate of increase in the size of overlap set, the U(Q, 1) is the expected daily unique user reach for Q, the U_{Q}_{ₘₐₓ} is the expected maximum unique user reach for Q over an unbounded time interval. In some embodiments, the U_{Q}_{ₘₐₓ} can be computed from historical data for a significantly longer time horizon, e.g. 10-12 months.

In some embodiments, the calculation for parameter β demands a substantial volume of data, making real-time computation unfeasible. However, β is sufficiently stable, experiencing minimal changes across various targeting cuts and time. Hence, the system can compute a single value of β, independent of Q, which allows for offline computation. In some embodiments, the parameter β can be updated periodically, e.g. once a month.

In FIG. 6, unique users to be reached by a campaign in the duration of N days are denoted by UserSet [1: N]; and unique users to be reached by the campaign on the (N+1)-th day are denoted by UserSet [N+1]. As shown in FIG. 6, in a scenario 610 with a smaller horizon time window, i.e. smaller N, an overlap Set 615 includes overlap users between the UserSet [1: N] and the UserSet [N+1]. In contrast, in a scenario 620 with a larger horizon time window, i.e. larger N, an overlap Set 625 includes overlap users between the UserSet [1: N] and the UserSet [N+1]. As can be seen from FIG. 6, the overlap Set 625 has a larger length than the overlap Set 615, which means the overlap Set 625 includes more unique users than the overlap Set 615. This is expected because: as N increases, the size of the UserSet [1: N] increases, i.e. there are more unique users reached in the N days. As such, there is a higher chance for a user in the UserSet [N+1], i.e. a user reached in the (N+1)-th day, to be also reached in the N days.

In some embodiments, once the parameter β is computed, it can be used to compute an overlap factor indicating a ratio between the size of the overlap set and the size of the UserSet [N+1], i.e. based on

$$\frac{Size ( overlap Set )}{Size ( UserSet [ N + 1 ] )} = 1 - exp ( - β * N ) .$$

Referring back to FIG. 5, based on the offline computed parameter β at block 2 562 and the

$$\frac{I}{U} ( Q , D )$$

computed at block 1 350, the system can forecast the

$$\frac{I}{U} ( Q , T ) ,$$

which represents impressions per user for the given targeting cut Q and campaign duration T days. The

$$\frac{I}{U} ( Q , T )$$

can be computed as:

$$\frac{I}{U} ( Q , T ) = \frac{I}{U} ( Q , D ) * \frac{T}{D} * \frac{1 - exp ( - β . D )}{1 - exp ( - β . T )} \qquad [ Eq2 ]$$

where the non-linear factor in the above expression is estimated using the exponentially saturating overlap model.

As shown in FIG. 5, the system can obtain forecasted available auction impressions 572, which are also forecasted available auction opportunities AO(Q, T) 572, from the internal API 570. Then at block 5 580, the system computes a maximum unique user reach, UniqueUsers(Q, T), for given targeting cut Q and campaign duration T, in real-time. For example, the system can divide the AO forecast AO(Q, T) 572 coming from the internal API 570, by the above estimated I/U ratio at block 3 564, to estimate the maximum count of unique users reachable by the given targeting cut Q and campaign duration T. This is the solution output for sub-problem 1, as follows:

$$UniqueUsers ( Q , T ) = \frac{AO ( Q , T )}{\frac{I}{U} ( Q , T )} \qquad [ Eq3 ]$$

As discussed above, the solution of sub-problem 1 is to estimate in real-time the UniqueUsers(Q, T), which refers to the maximum unique user reach for the given targeting cut Q and duration T. In contrast, the solution of sub-problem 2 is to estimate in real-time UniqueUsers(Q, T, b, B, c), which refers to the unique user reach forecast for winnable impressions with all of the above constraints specified by the advertisers, including additional constraints such as bid, budget and frequency cap constraints, provided by the advertiser.

In some embodiments, the arrival of impressions from a user is modelled as a Poisson process. To include the effect of the bid, the system can consume a probability of winning auctions 574, which can be represented as a predicted winrate winrate (Q, b, B) 574, from the internal API 570, as well as the above estimated

$$\frac{I}{U} ( Q , T )$$

at block 3 564, and then estimate the parameter of the Poisson process at block 4 566 to estimate impressions per user for all the constraints obtained from the campaign parameters 520. The estimated Poisson parameter, the winrate prediction 574 and the AO forecast 572 can be combined to compute the unique user reach forecast for these impressions winnable by the advertiser, at block 6 590, as a solution output for the sub-problem 2.

In some embodiments, the frequency cap constraint further reduces the AO available to an advertiser. The internal API 570 also provides a suppression ration 576 for the frequency cap, which can be represented as a factor FCR(c, Q, T, b, B) 576, by which the total AO forecast should be suppressed to arrive at the eligible AO for the advertiser. Using the above estimated

$$\frac{I}{U} ( Q , T )$$

at block 3 564, the parameter of the Poisson process from block 4 566, the AO forecast 572, the winrate prediction 574 and the suppression factor 576, the system can compute the user reach forecast with this additional constraint of frequency cap, at block 6 590, as a solution output for the sub-problem 2.

In some embodiments, the internal API 570 provides at least one of the AO forecast AO(Q, T) 572, the winrate prediction winrate (Q, b, B) 574 or the suppression factor FCR(c, Q, T, b, B) 576 based on historical user data and/or historical campaign data. For example, the AO forecast AO(Q, T) 572 is generated using a time series forecasting method based on historical data for the targeting tactic Q and the duration T. In some embodiments, each of the AO forecast AO(Q, T) 572, the winrate prediction winrate(Q, b, B) 574 and the suppression factor FCR(c, Q, T, b, B) 576 is generated using its own data model based on historical data.

In some embodiments, the AO forecast AO(Q, T) 572 is computed not only based on the duration length T, but also based on start and/or end dates of the campaign. For example, the AO forecast AO(Q, T) 572 is computed in view of any seasonal events or holidays falling in the duration T, as the auction opportunity can vary across seasons given the targeting tactic Q. Seasonality of user reach has an impact on the AO forecast AO(Q, T) 572, and in turn has an impact on the computation of outputs of the block 5 580 and the block 6 590.

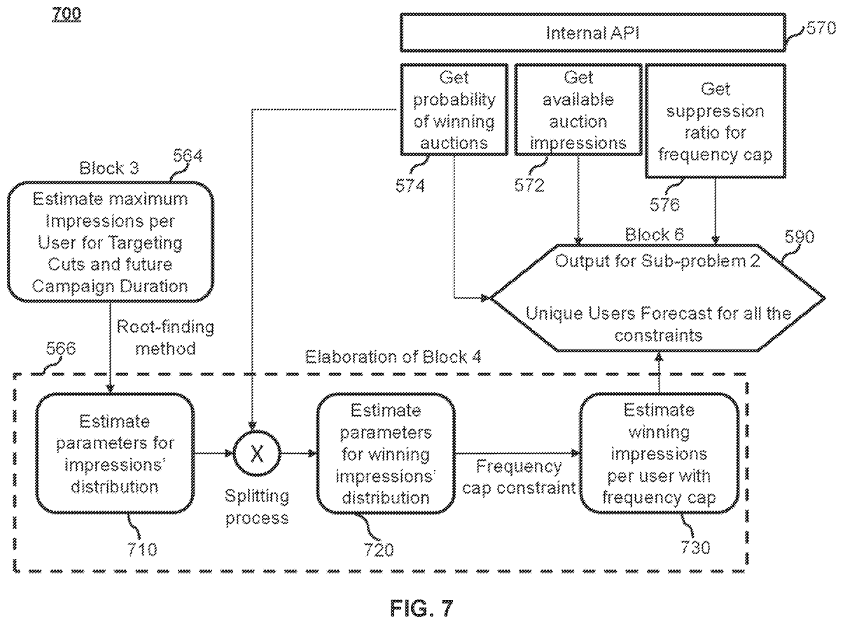

FIG. 7 illustrates a process 700 for estimating unique user reach for winnable impressions, in accordance with some embodiments of the present teaching. In some embodiments, the process 700 can be carried out by one or more computing devices, such as the server 104 and/or the user forecast computing device 102 of FIG. 1. For example, the process 700 shows a detailed process in the block 4 566 of FIG. 5.

As shown in FIG. 7, the

$$\frac{I}{U} ( Q , T )$$

is estimated from sub-problem 1 in block 3 564. Here, the impressions are also advertisement auction opportunities. Then the process 700 goes to block 4 566, which includes three sub-blocks 710, 720, 730.

At sub-block 710, parameters for a distribution of impressions are estimated. In some embodiments, the system can model arrival of impressions from a user as a Poisson process. Then, a mean of the standard Poisson distribution is estimated at the sub-block 710. The mean of a Zero-Truncated Poisson (ZTP) is equal to the impressions per user for the given targeting cut Q and campaign duration T, i.e.,

$${λ}_{Z T P} ( Q , T ) = \frac{I}{U} ( Q , T ) .$$

in some embodiments, the system can employ a Newton-Raphson method to estimate the mean of the standard Poisson distribution, λₚₒᵢₛₛₒₙ(Q, T).

At sub-block 720, parameters for a distribution of winning impressions are estimated. For example, a mean of the standard Poisson distribution for the winnable impressions is estimated at the sub-block 720. In some embodiments, the system utilizes a Poisson splitting process to divide the total advertisement auction opportunities (AO) into winnable impressions and non-winnable impressions, assuming winnable impressions is a random subset of total AO. Given query or targeting cut Q, bid value b and budget B, the system can obtain the probability of winning the auction from internal API 570, referred to as winrate(Q, b, B) 574. The winrate 574 is then used to determine the mean of the standard Poisson distribution for the winnable impressions after the Poisson splitting process, as described below:

$${λ}_{poisson \_ WI} ( Q , T , b , B ) = {λ}_{p o i s s o n} ( Q , T ) * winrate ( Q , b , B ) \qquad [ Eq4 ]$$

At sub-block 730, winning impressions per user with a frequency cap c, represented as

$$\frac{I}{U} ( Q , T , b , B , c ) ,$$

are estimated. In some embodiments, the system estimates an effective ZTP mean

$${λ}_{ZTP \_ WI} ( Q , T , b , B ) = \frac{I}{U} ( Q , T , b , B )$$

based on the λ_{poisson_WI}(Q, T, b, B) from sub-block 720. If the frequency cap constraint is not present, then

$$\frac{I}{U} ( Q , T , b , B , c ) = \frac{I}{U} ( Q , T , b , B ) .$$

Otherwise, the system estimates

$$\frac{I}{U} ( Q , T , b , B , c )$$

using the mean of impressions per user when subjected to a cap at c.

Then at block 6 590, the output for the sub-problem 2 is generated. In some embodiments, when the Frequency Cap suppression Ratio (FCR) 576 is available from the internal API 570, the value of winning impressions WI_{FC}(Q, T, b, B, c) is computed before estimating the UniqueUsers(Q, T, b, B, c) at block 6 590.

The FCR represents a ratio of impressions that can be served with frequency cap constraint to impressions that can be served without the frequency cap constraint. If there is no frequency capping constraint, FCR=1.

In some embodiments, with a given budget B and a bid-value b specified by the advertisers, the maximum winnable impressions are

$$\frac{B}{b} * 1000 ,$$

where the basis for employing the factor 1000 is attributed to the CPM (Cost per Mille) billing model. As such, the WI_{FC}(Q, T, b, B, c) is computed as:

$${WI}_{FC} ( Q , T , b , B , c ) = min [ ( AO ( Q , T ) * winrate ( Q , b , B ) * FCR ( c , Q , T , b , B ) ) , ( \frac{B}{b} * 1000 ) ] \qquad [ Eq 5 ]$$

Then similar to the unique user reach estimation outlined for the sub-problem 1, the system can estimate unique user reach given all constraints here as:

$$UniqueUsers ( Q , T , b , B , c ) = \frac{{WI}_{FC} ( Q , T , b , B , c )}{\frac{I}{U} ( Q , T , b , B , c )} \qquad [ Eq 6 ]$$

In some embodiments, the day-wise unique user reach forecast can be easily obtained by setting T=1 and taking the daily budget from the given budget B in Eq3 and Eq6.

In some embodiments, based on the outputs of the block 5 580 and/or the block 6 590, the advertiser can modify at least one of the campaign parameters 520, to optimize its campaign KPIs. For example, the advertiser can modify the targeting tactic, increase the number of keywords, change the bid budget, change the bid value, change the targeting audience, etc., to increase the forecasted unique user counts in the future time period.

In some embodiments, for the sub-problem 1 of maximum unique user reach estimation, additional notations include: UL_{Q}[1: N] denoting unique user set for Q for days 1 to N; and UL_{Q}[N: N] denoting unique user set for Q for the Nₜₕ day. To show some exemplary use cases for sub-problem 1, the system can model an overlap factor OF_{Q}(N) between users on successive days and cumulative user at any Nₜₕ day set for a given targeting cut Q, as previously shown in FIG. 6, using exponentially saturating overlap model as follows:

$${OF}_{Q} ( T ) = \frac{E [ Size ( {UL}_{Q} [ 1 : N ] ⋂ {UL}_{Q} [ N + 1 : N + 1 ] ) ]}{E [ Size ( {UL}_{Q} [ N + 1 : N + 1 ] ) ]} = 1 - exp ( - β . N )$$

where E[size(.)]=expected size of the set.

It follows that:

$$U ( Q , N + 1 ) = U ( Q , N ) + ( 1 - {OF}_{Q} ( N ) ) . U ( Q , 1 ) = U ( Q , N ) + exp ( - β . N ) . U ( Q , 1 )$$

The system can estimate the parameter β as follows:

$${U}_{{Q}_{max}} = U ( Q , 1 ) + exp ( - β ) U ( Q , 1 ) + exp ( - 2 β ) U ( Q , 1 ) + exp ( - 3 β ) U ( Q , 1 ) + ⋯$$

Summing the infinite series, one can achieve:

$${U}_{{Q}_{max}} = \frac{U ( Q , 1 )}{1 - exp ( - β )} .$$

As such:

$$β = - log ( 1 - \frac{U ( Q , 1 )}{{U}_{{Q}_{max}}} ) \qquad [ Eq 7 ]$$

After computing the parameter β, the system can estimate U(Q, T), given I(Q, D) and U(Q, D) for the given targeting cut Q as outlined below.

The U(Q, T) can be expressed as:

$$U ( Q , T ) = U ( Q , 1 ) + exp ( - β ) . U ( Q , 1 ) + ⋯ + exp ( - ( T - 1 ) . β ) . U ( Q , 1 ) = ( \frac{1 - exp ( - β . T )}{1 - exp ( - β )} ) . U ( Q , 1 ) \qquad [ Eq 8 ]$$

Computing U(Q, T) from Eq8 requires U(Q, 1), which is not readily available in historical sampled data for D days stored in the fast access database 540. Hence, to compute unique user reach forecast in real-time, the system can derive U(Q, T) in terms of U(Q, D). Based on the Eq8 expression, the system can compute U(Q, T) in terms of U(Q, D) as follows:

$$\frac{U ( Q , T )}{U ( Q , D )} = \frac{1 - exp ( - β . T )}{1 - exp ( - β . D )} \qquad [ Eq 9 ]$$

One can reasonably infer that impressions exhibit a linear scaling pattern over time, i.e.,

$$\frac{I ( Q , T )}{I ( Q , D )} = \frac{T}{D} ,$$

so along with the help of Eq9, the system can obtain:

$$\frac{I}{U} ( Q , T ) = \frac{I}{U} ( Q , D ) * \frac{T}{D} * \frac{1 - exp ( - β . D )}{1 - exp ( - β . T )} \qquad [ Eq 10 ]$$

Finally, the U(Q, T) is computed as:

$$U ( Q , T ) = \frac{AO ( Q , T )}{\frac{I}{U} ( Q , T )}$$

There are some use cases for sub-problem 2, with targeting cut Q, duration T, bid-value b, budget B, and/or frequency cap c. In a first case A: all constraints except frequency cap c are applied.

In the first case A, the system initially estimates

$$\frac{I}{U} ( Q , T )$$

from sub-problem 1 using Eq10. Here, impressions are advertisement auction opportunities. By modelling arrival of impressions from a user as a Poisson process, the system can have a mean of Zero-Truncated Poisson (ZTP) equal to the impressions per user for the given targeting cut Q and campaign duration T, i.e.,

$${λ}_{ZTP} ( Q , T ) = \frac{I}{U} ( Q , T ) \qquad [ Eq 11 ]$$

The system then estimates the standard Poisson distribution parameter, λₚₒᵢₛₛₒₙ(Q, T), from λ_{ZTP}(Q, T) using the equation below:

$$\frac{{λ}_{poisson} ( Q , T )}{1 - exp ( - {λ}_{poisson} ( Q , T ) )} = {λ}_{ZTP} ( Q , T ) \qquad [ Eq 12 ]$$

As Eq12 does not have a closed-form solution, the system solves this equation using numerical techniques such as Newton-Raphson method, according to some embodiments.

With the help of an internal API, given query Q, bid value b and budget B, the system can estimate probability of winning the auction, i.e., winrate(Q, b, B). The property of Poisson splitting process is utilized to determine the parameter for the split process for the winnable impressions, which is itself a Poisson process, described below:

$${λ}_{poisson \_ WI} = {λ}_{poisson} ( Q , T ) * winrate ( Q , b , B ) \qquad [ Eq 13 ]$$

After splitting the total advertisement auction opportunities into winnable and non-winnable impressions, assuming winnable impressions is a random subset of the total advertisement auction opportunities, the system has:

$$WI ( Q , T , b , B ) = AO ( Q , T ) * winrate ( Q , b , B ) \qquad [ Eq 14 ]$$

The effective ZTP mean for given budget B and bid-value b can be computed as:

$${λ}_{ZTP \_ WI} ( Q , T , b , B ) = \frac{{λ}_{poisson \_ WI} ( Q , T , b , B )}{1 - exp ( {λ}_{poisson \_ WI} ( Q , T , b , B ) )}$$

$${λ}_{ZTP \_ WI} ( Q , T , b , B ) = \frac{{λ}_{poisson \_ WI} ( Q , T ) * winrate ( Q , b , B )}{1 - exp ( {λ}_{poisson \_ WI} ( Q , T ) * winrate ( Q , b , B ) )}$$

Similar to Eq11, the impressions per user for the given constraints provided by the advertiser can be computed as:

$$\frac{I}{U} ( Q , T , b , B ) = {λ}_{ZTP \_ WI} ( Q , T , b , B ) = \frac{{λ}_{poisson} ( Q , T ) * winrate ( Q , b , B )}{1 - exp ( - {λ}_{poisson} ( Q , T ) * winrate ( Q , b , B ) )} \qquad [ Eq 15 ]$$

Finally, using Eq14 and Eq15, one can compute U(Q, T, b, B) as:

$$U ( Q , T , b , B ) = \frac{WI ( Q , T , b , B )}{\frac{I}{U} ( Q , T , b , B )} \qquad [ Eq 16 ]$$

$$U ( Q , T , b , B ) = \frac{AO ( Q , T ) * winrate ( Q , b , B )}{\frac{I}{U} ( Q , T , b , B )} \qquad [ Eq 17 ]$$

In a second case B for sub-problem 2 additional constraint of frequency cap FC=c is also applied. The second case B includes: a sub-case B-1 where campaign budget has a value such that the campaign is not able to exhaust the budget; and a sub-case B-2 where campaign budget has a value such that the campaign can exhaust the budget.

Under the sub-case B-1, the system uses a frequency cap suppression ratio (FCR) model to get the suppression ratio to estimate the frequency capped WI as:

$${WI}_{FC} ( Q , T , b , B , c ) = WI ( Q , T , b , B ) * FCR ( c , Q , T , b , B )$$

Using Eq14, the system has:

$${WI}_{FC} ( Q , T , b , B , c ) = AO ( Q , T ) * winrate ( Q , b , B ) * FCR ( c , Q , T , b , B ) \qquad [ Eq 18 ]$$

With the definition of FCR, the equation reads as follows,

$$FCR ( c , Q , T , b , B ) = \frac{{\sum }_{i = 1}^{c - 1} i . P ( X = 1 ) + {\sum }_{i = c}^{∞} c . P ( X = 1 )}{{λ}_{ZTP \_ WI} ( Q , T , b , B )} \qquad [ Eq 19 ]$$

Moreover, the presence of frequency capping introduces an impact on λ_{ZTP_WI} as follows:

$${λ}_{ZTP \_ WI} ( Q , T , b , B , c ) = \frac{I}{U} ( Q , T , b , B , c ) = {\sum }_{i = 1}^{c - 1} i . P ( X = 1 ) + {\sum }_{i = c}^{∞} c . P ( X = 1 ) \qquad [ Eq 20 ]$$

where X is a random variable with probability distribution given as:

$$X \sim ZTP ( {λ}_{ZTP \_ WI} ( Q , T , b , B ) )$$

With the help of Eq16, Eq18, Eq19 and Eq20, the system can achieve:

$${U}_{Q} ( T , b , B , c ) = \frac{{WI}_{FC} ( Q , T , b , B , c )}{{λ}_{ZTP \_ WI} ( Q , T , b , B , c )} = \frac{AO ( Q , T ) * winrate ( Q , b , B ) * FCR ( c , Q , T , b , B )}{{λ}_{ZTP \_ WI} ( Q , T , b , B , c )} \qquad [ Eq 21 ]$$

$$U ( Q , T , b , B , c ) = \frac{AO ( Q , T ) * winrate ( Q , b , B )}{\frac{I}{U} ( Q , T , b , B )} \qquad [ Eq 22 ]$$

As can be seen, Eq17 and Eq22 are the same, i.e., unique user reach estimation remains unchanged in the sub-case B-1.

In the sub-case B-2, campaign budget enables the campaign to exhaust the budget. Then, one can infer that Eq18 remains valid under the condition where the advertiser engages in all advertisement auction opportunities (AO), signifying an ample budget without imposing restrictions on AO line items.

But in scenarios with finite constrained budgets, the WI_{FC}(Q, T, b, B, c) experiences an alteration. The system can compute:

$${WI}_{FC} ( Q , T , b , B , c ) = min [ ( AO ( Q , T ) * winrate ( Q , b , B ) * FCR ( c , Q , T , b , B ) ) , ( \frac{B}{b} * 1000 ) ]$$

In some embodiments, when budget is limited in the sub-case B-2,

$${WI}_{FC} ( Q , T , b , B , c ) = \frac{B}{b} * 1000.$$

The basis for employing the factor 1000 is attributed to the CPM (Cost per Mille) billing. The system can obtain λ_{ZTP_WI}(Q, T, b, B, c) from Eq20. Hence, one can have:

$$U ( Q , T , b , B ) = \frac{B / b * 1000}{\frac{I}{U} ( Q , T , b , B , c )} \qquad [ Eq 23 ]$$

As can be seen, in this sub-case B-2, unique user reach is impacted by the frequency cap constraint c.

In some embodiments, user interfaces are provided by a server, e.g. the server 104 or the user forecast computing device 102 in FIG. 1, to advertisers on a campaign setup and management platform of a retailer.

In some embodiments, an advertiser can log in on a campaign setup and management platform via a user interface to create a new campaign. The user interface may include a line item name section for the advertiser to enter a name of the campaign; and include a line item type section for the advertiser to select a type of the campaign. For example, the type of the campaign can be display advertisements or video advertisements.

In some embodiments, a user interface including a targeting tactic section and a keyword targeting section is shown to an advertiser. The targeting tactic section is for the advertiser to select a targeting tactic or strategy. For example, a targeting tactic can be based on: a contextual targeting where advertisements appear when customers search or browse relevant category and product pages; a behavioral targeting where advertisements are shown to customers who already shopped a specified brand or brand category; a keyword targeting where advertisements appear based on the keywords that customer uses to search products and brands; or a run of site (ROS) where advertisements appear and rotate on any page excluding the homepage. In some embodiments, the targeting tactic section can also provide other options of targeting tactic to enable advertisements to appear to a customer based on: account information of the customer, the customer's IP address, a location of a physical store selected by the customer, a previously stored delivery address of the customer, or other information related to the customer's historical transactions with the retailer.

In some embodiments, the keyword targeting section is shown in the user interface only after the keyword targeting is selected by the advertiser. The keyword targeting section is for the advertiser to configure the corresponding targeting cuts of the targeting tactic. For example, after two target keywords “laptop” and “computers” are configured by the advertiser for the new campaign, advertisements of the campaign are expected to appear when any of the two target keywords “laptop” and “computers” matches the keywords used by a customer to search products and brands. In some embodiments, the advertiser can alternatively or additionally configure one or more negative keywords, such that the advertisements of the campaign can appear only when none of the negative keywords match the keywords used by a customer to search products and brands. In either case, the match can be a broad match or an exact match, upon selection of the advertiser.

In some embodiments, a user interface including a scheduling section and a budget and bidding section is shown to an advertiser. The scheduling section is for the advertiser to enter start and end dates for the campaign. Accordingly, the system will provide unique user forecast for the entire duration between the start date and the end date. In some embodiments, the system also provides forecast on each day of the duration. In some examples, the advertiser can optionally enter a frequency cap under the scheduling section as well. For example, the advertiser can enter a limit per day, per week, or per month, as the frequency cap on the maximum number of impressions from any user regarding the advertisement of the campaign.

In some embodiments, the budget and bidding section in the user interface is for the advertiser to provide budget and bidding values. For example, the advertiser can select a budget type, a daily budget value, and bid parameters. These parameters can be used to determine how many impressions will be won by the advertiser. The system will provide unique user forecast for total supply as well as winning impressions.

In some embodiments, any or each of the user interfaces described above also includes a summary section listing all parameters provided by the advertiser. In some embodiments, any or each of the user interfaces described above also includes an option for the advertiser to select to run a user forecast application. In some embodiments, the system provides an additional user interface, after the advertiser enters information on any or each of the user interfaces described above, to include an option for the advertiser to select to run the user forecast application. In some embodiments, after collecting the parameters provided by the advertiser in any or each of the user interfaces described above, the system automatically runs the user forecast application. In some embodiments, the user forecast application is run based on any of the disclosed methods in FIGS. 1-7.

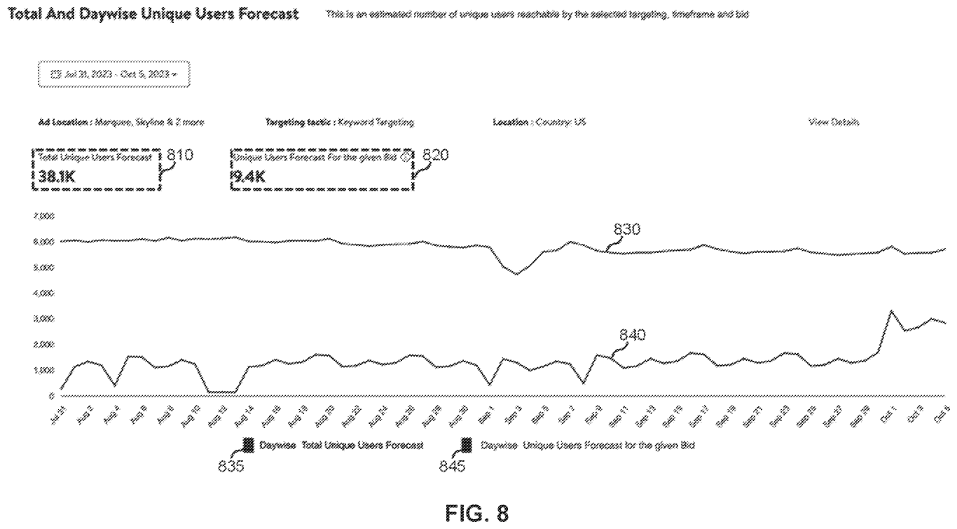

FIG. 8 shows a user interface 800 including user forecast results based on running the user forecast application. As shown in FIG. 8, the user forecast results include total and day-wise unique user forecast results for the campaign. These forecast results are based on the selected targeting, start and end dates, bid values, etc.

As shown in FIG. 8, the user interface 800 shows a total unique users forecast 810 of value 38.1 K. This is a forecasted maximum number of unique users reachable based on the keyword targeting in the duration Jul. 31, 2023 to Oct. 5, 2023, which is a future duration at the time of the test, assuming the advertiser will win all auction opportunities or impressions for the matched keywords.

In addition, the user interface 800 also shows a unique users forecast for the given bid 820 of value 9.4 K. This is a forecasted total number of unique users in the future duration Jul. 31, 2023 to Oct. 5, 2023, for winning auction opportunities or impressions of the advertiser given the bid value data and the budget data. Accordingly, the unique users forecast for the given bid 820 is smaller than or at most equal to the total unique users forecast 810.

As shown in FIG. 8, the user interface 800 also shows two plots: a first plot 830 and a second plot 840. The first plot 830 corresponds to a notation 835 of day-wise total unique users forecast, which is a forecast of daily maximum number of unique users, assuming the advertiser will win all auction opportunities or impressions for the matched keywords. The second plot 840 corresponds to a notation 845 of day-wise unique users forecast for the given bid, which is a forecast of daily total number of unique users given the bid value data and the budget data, for winning auction opportunities or impressions of the advertiser. The second plot 840 cannot be higher than the first plot 830.

The forecast of day-wise unique users cannot be added to arrive at the forecast of the entire future duration, because there will be some common users across days. In the example shown in FIG. 8, the day-wise user forecast counts along the first plot 830 in the entire future duration Jul. 31, 2023 to Oct. 5, 2023 will be added up to more than 300 K, which is way larger than the total unique users forecast 810 of value 38.1 K.

As such the present teaching discloses a user reach forecast method, which can be used in a campaign management tool provided by a retailer to advertisers, including advertisers whose primary objective is to maximize user reach. There will be a multi-fold impact on the online advertisement revenue of the retailer from this user reach forecast method. When advertisers are planning and setting up their display advertising campaigns, they have some KPI based goals. When the retailer provides a forecast of user reach, the advertisers are able to optimize their advertising campaign parameters from multiple angles. This will boost advertisement revenue of the retailer and build trust to the retailer in the long run.

In some examples, advertisers wants to perform an advertising campaign budget optimization. The advertisers set up advertising budgets according to some KPI based goals. Based on the accurate user reach forecast disclosed above, the advertisers will be able do accurate budget optimization of their campaigns. This helps in optimizing advertisement revenue of the retailer.

In some examples, advertisers wants a full utilization of the advertising campaign budget. The advertisers may have set up very large campaign budgets. But they may make other parameters very restrictive if they do not have accurate user reach forecast, which will lead to unspent campaign budgets which will reduce advertisement revenue of the retailer. The accurate user reach forecast disclosed above will prevent this revenue loss.

In some examples, the accurate user reach forecast disclosed above helps to enhance advertiser satisfaction resulting in more advertisement and sales revenue. The accurate user reach forecast helps advertisers to manage their campaign parameters so as to reach their KPI based goals such as conversion rate, brand awareness, user reach etc. Without this forecast tool, they may set up arbitrary values of the campaign parameters, resulting in low performance of their advertising campaigns, which leads to dissatisfaction. The accurate user reach forecast disclosed above enhances advertiser satisfaction, which will make the retailer a trusted advertising partner and bring in more advertisement budget from existing advertisers as well as new advertisers. As this user reach forecast will foster stronger relationships with brand sellers and marketplace sellers, there will be a positive impact on sales revenue as well.

In some examples, the accurate user reach forecast disclosed above helps the retailer to gain a competitive edge. By offering a unique solution that enables real-time unique user reach forecast, the retailer gains a competitive edge in the online advertising arena. Advertisers are drawn to advertising platforms that provide advanced tools for campaign planning and management, potentially leading to an increase in the number of advertisers choosing the retailer's advertising platform.

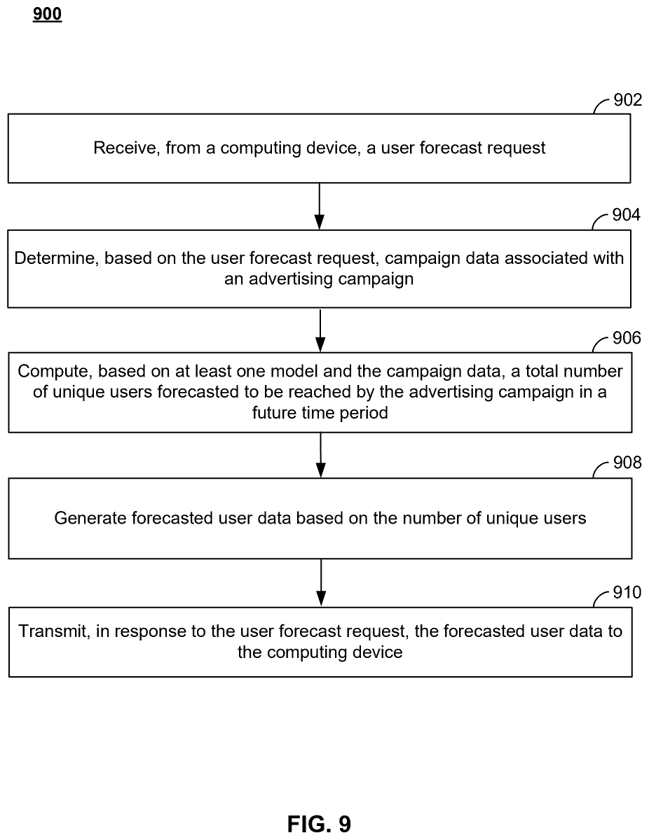

FIG. 9 is a flowchart illustrating an exemplary method 900 for forecasting unique user counts for advertising campaigns, in accordance with some embodiments of the present teaching. In some embodiments, the method 900 can be carried out by one or more computing devices, such as the user forecast computing device 102 and/or the cloud-based engine 121 of FIG. 1. Beginning at operation 902, a user forecast request is received from a computing device. At operation 904, campaign data associated with an advertising campaign is determined based on the user forecast request. At operation 906, a total number of unique users forecasted to be reached by the advertising campaign in a future time period is computed based on at least one model and the campaign data. At operation 908, forecasted user data is generated based on the number of unique users. At operation 910, the forecasted user data is transmitted to the computing device in response to the user forecast request.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
receive, from a computing device, a user forecast request,
determine, based on the user forecast request, campaign data associated with an advertising campaign,
compute, based on at least one model and the campaign data, a total number of unique users forecasted to be reached by the advertising campaign in a future time period,
generate forecasted user data based on the number of unique users, and
transmit, in response to the user forecast request, the forecasted user data to the computing device.

2. The system of claim 1, wherein the campaign data associated with the advertising campaign comprises:
a targeting strategy for the advertising campaign;
targeting criteria associated with the targeting strategy;
a start date of the advertising campaign;
an end date of the advertising campaign;
bid value data configured for the advertising campaign;
budget data configured for the advertising campaign; and
a frequency cap indicating a maximum number of impressions that can be served by the advertising campaign to any user within the future time period.

3. The system of claim 2, wherein:
the advertising campaign is generated for an advertiser to advertise at least one item on a website of a retailer;
at least part of the campaign data was configured by the advertiser; and
the forecasted user data helps the advertiser to re-configure at least one of the campaign data.

4. The system of claim 3, wherein the total number of unique users is computed based on:
obtaining a historical sampled dataset including historical campaign data and historical user data for advertising campaigns over a past time period, wherein the advertising campaigns are generated for advertisers giving the same targeting strategy and the same targeting criteria as the advertiser; and
computing, based on the historical sampled dataset, a first impression-to-user ratio for the past time period regarding the targeting strategy and the targeting criteria.

5. The system of claim 4, wherein the total number of unique users is computed further based on:
computing, asynchronously offline, a parameter using an exponentially saturating overlap model based on historical user and campaign data, wherein the parameter indicates a rate of size increase of an overlap user set between unique users in a duration of N days and unique users on (N+1)-th day, wherein N is an integer larger than or equal to one; and
computing, asynchronously offline based on the parameter, an overlap factor between users on successive days using the exponentially saturating overlap model.

6. The system of claim 5, wherein the total number of unique users is computed further based on:
computing, synchronously in real-time, a second impression-to-user ratio for the future time period regarding the targeting strategy and the targeting criteria, based on the first impression-to-user ratio and the overlap factor.

7. The system of claim 6, wherein the total number of unique users is computed further based on:
obtaining auction opportunity data for the future time period regarding the targeting strategy and the targeting criteria, wherein the auction opportunity data is generated based on historical user and campaign data; and
computing, synchronously in real-time, a maximum number of unique users to be reached by the advertising campaign in the future time period based on the auction opportunity data and the second impression-to-user ratio, given an assumption that the advertiser would have won all auction opportunities for the future time period regarding the targeting strategy and the targeting criteria.

8. The system of claim 7, wherein the total number of unique users is computed further based on:
obtaining a win rate indicating a probability of winning an auction by the advertiser, based on: the targeting strategy, the targeting criteria, the bid value data, and the budget data; and
obtaining a frequency cap suppression ratio representing a ratio of expected impressions to be served with the frequency cap in the future time period to expected impressions to be served without the frequency cap in the future time period, based on: the targeting strategy, the targeting criteria, the bid value data, and the budget data,
wherein at least one of the auction opportunity data, the win rate, or the frequency cap suppression ratio is generated based on historical user and campaign data.

9. The system of claim 8, wherein the total number of unique users is computed further based on:
estimating, based on the second impression-to-user ratio, a first mean of a standard Poisson distribution for all impressions in the future time period regarding the targeting strategy and the targeting criteria;
estimating, based on the first mean and the win rate, a second mean of a standard Poisson distribution for winnable impressions of the advertiser in the future time period regarding the targeting strategy and the targeting criteria; and
computing, synchronously in real-time based on the second mean and the frequency cap, a third impression-to-user ratio for the future time period regarding the targeting strategy and the targeting criteria, subject to: the bid value data, the budget data and the frequency cap.

10. The system of claim 9, wherein the total number of unique users is computed further based on:
computing, synchronously in real-time, the total number of unique users to be reached by the advertising campaign in the future time period based on: the third impression-to-user ratio, the auction opportunity data, the win rate and the frequency cap.

11. The system of claim 10, wherein the forecasted user data comprises:
the maximum number of unique users in the future time period given the targeting strategy, the targeting criteria and the duration;
the total number of unique users in the future time period given the bid value data, the budget data and the frequency cap;
a first plot of daily maximum number of unique users given the targeting strategy, the targeting criteria and the duration; and
a second plot of daily total number of unique users given the bid value data, the budget data and the frequency cap.

12. The system of claim 1, wherein:
the at least one model includes a machine learning model trained based on historical user and campaign data.

13. A computer-implemented method, comprising:
receiving, from a computing device, a user forecast request;
determining, based on the user forecast request, campaign data associated with an advertising campaign;
computing, based on at least one model and the campaign data, a total number of unique users forecasted to be reached by the advertising campaign in a future time period;
generating forecasted user data based on the number of unique users; and
transmitting, in response to the user forecast request, the forecasted user data to the computing device.

14. The computer-implemented method of claim 13, wherein:
the campaign data associated with the advertising campaign comprises:
a targeting strategy for the advertising campaign,
targeting criteria associated with the targeting strategy,
a start date of the advertising campaign,
an end date of the advertising campaign,
bid value data configured for the advertising campaign,
budget data configured for the advertising campaign, and
a frequency cap indicating a maximum number of impressions that can be served by the advertising campaign to any user within the future time period;
the advertising campaign is generated for an advertiser to advertise at least one item on a website of a retailer;
at least part of the campaign data was configured by the advertiser; and
the forecasted user data helps the advertiser to re-configure at least one of the campaign data.

15. The computer-implemented method of claim 14, wherein computing the total number of unique users comprises:
obtaining a historical sampled dataset including historical campaign data and historical user data for advertising campaigns over a past time period, wherein the advertising campaigns are generated for advertisers giving the same targeting strategy and the same targeting criteria as the advertiser;
computing, based on the historical sampled dataset, a first impression-to-user ratio for the past time period regarding the targeting strategy and the targeting criteria;
computing, asynchronously offline, a parameter using an exponentially saturating overlap model based on historical user and campaign data, wherein the parameter indicates a rate of size increase of an overlap user set between unique users in a duration of N days and unique users on (N+1)-th day, wherein N is an integer larger than or equal to one;
computing, asynchronously offline based on the parameter, an overlap factor between users on successive days using the exponentially saturating overlap model; and
computing, synchronously in real-time, a second impression-to-user ratio for the future time period regarding the targeting strategy and the targeting criteria, based on the first impression-to-user ratio and the overlap factor.

16. The computer-implemented method of claim 15, wherein computing the total number of unique users further comprises:
obtaining auction opportunity data for the future time period regarding the targeting strategy and the targeting criteria, wherein the auction opportunity data is generated based on historical user and campaign data; and
computing, synchronously in real-time, a maximum number of unique users to be reached by the advertising campaign in the future time period based on the auction opportunity data and the second impression-to-user ratio, given an assumption that the advertiser would have won all auction opportunities for the future time period regarding the targeting strategy and the targeting criteria.

17. The computer-implemented method of claim 16, wherein computing the total number of unique users further comprises:
obtaining a win rate indicating a probability of winning an auction by the advertiser, based on: the targeting strategy, the targeting criteria, the bid value data, and the budget data; and
obtaining a frequency cap suppression ratio representing a ratio of expected impressions to be served with the frequency cap in the future time period to expected impressions to be served without the frequency cap in the future time period, based on: the targeting strategy, the targeting criteria, the bid value data, and the budget data,
wherein at least one of the auction opportunity data, the win rate, or the frequency cap suppression ratio is generated based on historical user and campaign data.

18. The computer-implemented method of claim 17, wherein computing the total number of unique users further comprises:
estimating, based on the second impression-to-user ratio, a first mean of a standard Poisson distribution for all impressions in the future time period regarding the targeting strategy and the targeting criteria;
estimating, based on the first mean and the win rate, a second mean of a standard Poisson distribution for winnable impressions of the advertiser in the future time period regarding the targeting strategy and the targeting criteria;
computing, synchronously in real-time based on the second mean and the frequency cap, a third impression-to-user ratio for the future time period regarding the targeting strategy and the targeting criteria, subject to: the bid value data, the budget data and the frequency cap; and
computing, synchronously in real-time, the total number of unique users to be reached by the advertising campaign in the future time period based on: the third impression-to-user ratio, the auction opportunity data, the win rate and the frequency cap.

19. The computer-implemented method of claim 18, wherein the forecasted user data comprises:
the maximum number of unique users in the future time period given the targeting strategy, the targeting criteria and the duration;
the total number of unique users in the future time period given the bid value data, the budget data and the frequency cap;
a first plot of daily maximum number of unique users given the targeting strategy, the targeting criteria and the duration; and
a second plot of daily total number of unique users given the bid value data, the budget data and the frequency cap.

20. A non-transitory computer readable medium having instructions stored thereon, wherein the instructions, when executed by at least one processor, cause at least one device to perform operations comprising:
receiving, from a computing device, a user forecast request;
determining, based on the user forecast request, campaign data associated with an advertising campaign;
computing, based on at least one model and the campaign data, a total number of unique users forecasted to be reached by the advertising campaign in a future time period;
generating forecasted user data based on the number of unique users; and
transmitting, in response to the user forecast request, the forecasted user data to the computing device.
